(19) United States
(12) Patent Application Publication
(10) Pub. No.: US 2018/0053387 A1
(43) Pub. Date: Feb. 22, 2018

(54) ANTI-THEFT/ANTI-ATTACKER/LOCATOR CELLPHONE CASING

(71) Applicant: AARON MONTEJO ARCAYA, Sacarmento, CA (US)

(72) Inventor: AARON MONTEJO ARCAYA, Sacarmento, CA (US)

(21) Appl. No.: 15/477,116

(22) Filed: Apr. 3, 2017

(30) Foreign Application Priority Data
Aug. 16, 2016 (PH) 12016000280

(51) Int. Cl. G08B 13/14

(52) U.S. Cl. CPC G08B 13/149; A45C 2011/002

(57) ABSTRACT

An anti-theft/anti-attacker/locator cellphone casing in various shapes, sizes and colors for various cellphone brands which has a wireless magnetic sensor within and includes a magnetic stick and wireless remote control, if any. The alarm of the cellphone casing is activated/deactivated using a manual or wireless remote control switch. When the alarm is activated and the magnetic sensor inside the cellphone casing is detached from the magnetic stick beyond 10 millimeters, the cellphone casing will automatically sound off signaling that the cellphone has been taken away from the individual/owner to frighten off possible thieves/attackers and to locate the cellphone.

This application relates to the anti-theft/anti-attacker/locator cellphone casing in various shapes, sizes and colors for various cellphone brands, particularly, having a wireless magnetic sensor with magnetic stick, and manual or wireless remote control on/off switch which can control the activation/deactivation of the alarm to frighten off possible thieves/attackers and to locate the cellphone.

Cellphones come in various shapes, sizes and colors for various brands. Since cellphones are expensive, stealing of these gadgets from individuals/owners or showrooms is rampant nowadays in most places.

Smart cellphone casings are currently available in the market that protect people from attacks. A manual on/off switch on the casing is used to activate/deactivate the alarm. There is no cellphone casing currently available in the market that uses a remote control specific to the cellphone that controls the alarm.

Further, the anti-theft devices for cellphones existing in the market typically uses blue tooth within a range of at most 30 meters, and software applications which will require internet access to locate the cellphone. There is a high possibility that the thief has already gone off with the cellphone before the individual/owner knows that his cellphone has been stolen.

Hence, the primary object of the subject utility model is to provide a cellphone casing in various shapes, sizes and colors for various cellphone brands that automatically produces a loud sound/alarm through manual or wireless remote control on/off switch when the magnetic sensor inside the cellphone casing is detached from the magnetic stick beyond 10 millimeters to signal that the cellphone has been taken away from the individual/owner. This will give warning to anyone around and to frighten off possible thieves/attackers.

Another object is to provide a cellphone casing that that has an option to use wireless remote control specific to the cellphone that can activate/deactivate the alarm. Other remote controls cannot activate/deactivate the alarm produced by the cellphone casing.

Still another object is to provide a cellphone casing that has an option to use wireless remote control that can locate lost cellphone casing within 20 to 30 meters through the alarm sound.

These and other objects of the present utility model will become evident upon further review of the specification and drawings, as follows:

Using Manual On/Off Switch:

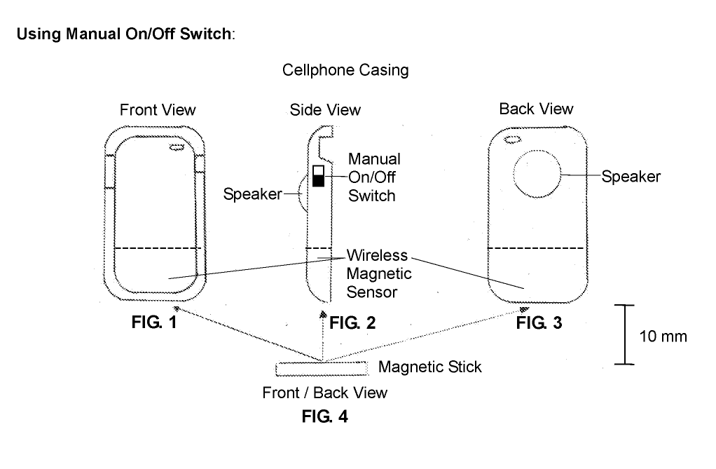

FIG. 1 is the front view of the preferred example of the present utility model for the cellphone casing using manual on/off switch;

FIG. 2 is the side view thereof;

FIG. 3 is the back view thereof; and

FIG. 4 is the front/back view of the magnetic stick.

Using Remote Control Switch Specific to Cellphone Casing:

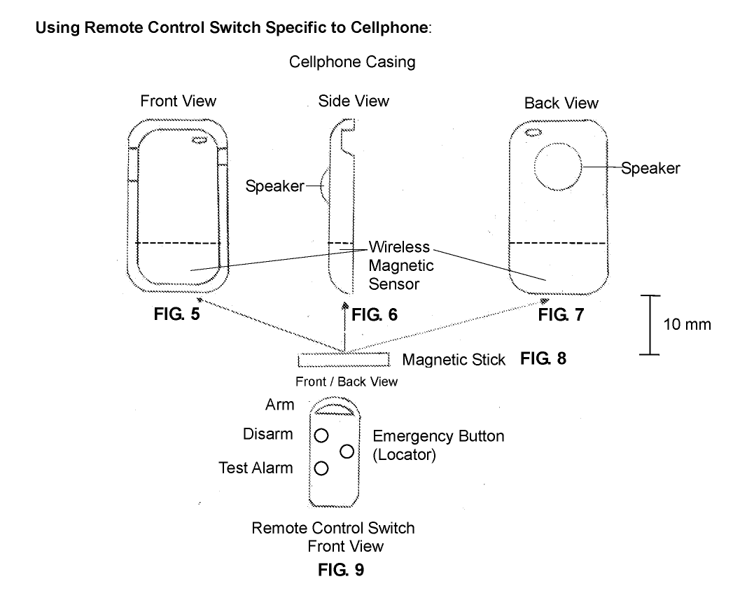

FIG. 5 is the front view of the preferred example of the present utility model for the cellphone casing using wireless remote control switch specific to the cellphone casing;

FIG. 6 is the side view thereof;

FIG. 7 is the back view thereof;

FIG. 8 is the front/back view of the magnetic stick; and

FIG. 9 is the front view of the remote control switch.

In reference to the drawing in detail, the anti-theft/anti-attacker/locator cellphone casing has a wireless magnetic sensor at the bottom and comes with a magnetic stick and wireless remote control switch, if any. When the alarm is activated and the magnetic sensor inside the cellphone casing is detached from the magnetic stick beyond 10 millimeters, the cellphone casing will automatically sound off signaling that the cellphone has been taken away from the individual/owner.

The alarm of the cellphone casing is activated/deactivated using a manual or wireless remote control switch as shown in FIGS. 2 and 9, respectively.

1. A cellphone casing comprising various shapes, sizes and colors for various cellphone brands.

2. A cellphone casing of claim 1, wherein said casing produces a loud sound/alarm through manual or wireless remote control on/off switch to give warning to anyone around and to frighten off possible attackers.

3. A cellphone casing of claim 1, wherein said casing automatically alarms when activated and when the magnetic sensor inside the cellphone casing is detached from the magnetic stick beyond 10 millimeters to signal that the cellphone has been taken away from the individual/owner.

4. A cellphone casing of claim 2, wherein said wireless remote control activates/deactivates the alarm specific to the cellphone.

5. A cellphone casing of claim 2, wherein said wireless remote control locates lost cellphone casing within 20 to 30 meters through the alarm sound.
